(19) United States
(12) Patent Application Publication
(10) Pub. No.: US 2005/0191162 A1
(43) Pub. Date: Sep. 1, 2005

(54) Method for integrating interbay and intrabay material transportation systems within an integrated circuit factory

(76) Inventors: Simon Chang, Pingjhen City (TW); Nain-Sung Lee, Hsin-Chu City (TW); Yung-Chang Peng, Jhubei City (TW)

Correspondence Address: DUANE MORRIS, LLP;IP DEPARTMENT, ONE LIBERTY PLACE, PHILADELPHIA, PA, 19103-7396, US

(21) Appl. No.: 10/787,485

(22) Filed: Feb. 26, 2004

(51) Int. Cl. B65G 1/00

(52) U.S. Cl. 414/626

(57) ABSTRACT

An integrated material transport system in an integrated circuit manufacturing factory is disclosed. The system comprises a first material transport subsystem traveling at a first height, and a second material transport subsystem traveling at a second height. There is at least one shared material transfer port to be used by both the first and second transport subsystems. Further, there is an integrated rail subsystem servicing both the first and second material transport subsystems for exchanging predetermined materials through the shared material transfer port with a predetermined material stocker under a ceiling with a uniform height.

### BACKGROUND

The present disclosure relates to material management techniques in an integrated circuit factory, and more particularly, relates to methods for integrating separate interbay and intrabay material transport systems into a single efficient transport system.

The manufacture of integrated circuits (IC) requires many production process steps. The process tools used within specific processing areas or production bays of a typical high-volume production facility are usually segregated by a common characteristic. This common characteristic may include the production tool type, process type and/or production process sequence. During the production flow of an IC, the production material may visit many different production bays as well as the same bay(s) many times. IC manufacturing factories have set up automation-controlled production material handling systems to help transport the material in various stages of completion within the production facility to and from the production bays. In addition, these material transport systems are also used to transport material between storage or stocking locations for holding material in cue for processing.

The block diagram shown in FIG. 1 illustrates the use of material transport systems to move material in a typical IC factory 100. Production bays X 102, Y 104 and Z 106 are shown, comprised of bay production tools X 108, Y 110 and Z 112 and bay stockers X 114, Y 116 and Z 118. The bay production tools X 108, Y 110 and Z 112 and bay stockers X 114, Y 116 and Z 118 are themselves usually not transportable and are established as fixtures within their assigned production bays X 102, Y 104 and Z 106, respectively. An Over Head Transport (OHT) system 120 transports the production material within (intrabay) each production bay X 102, Y 104 or Z 106, i.e., between the bay's stocker X 114, Y 116 or Z 118 and the bay's production tool X 108, Y 110 or Z 112, as well as between the various production bay tools contained within each bay. The OHT system 120 also moves material in and out of the bay stockers X 114, Y 116 or Z 118 to other bay stockers X 114, Y 116 or Z 118 (interbay). Production material is usually held within a transport pod or a cassette fixture during transport by the OHT system 120. A typical OHT system 120 is constructed as either a rail or conveyor system located above the manufacturing tools and work areas, with attached platforms or vehicles for moving the pods or cassettes on predetermined routes or tracks. The OHT system 120 may have many platforms/vehicles not necessarily unique to, nor assigned to any specific stocker or bay. The OHT system 120 serves as the primary system for moving production material throughout the manufacturing facility.

FIG. 1 also illustrates an Over Head Shuttle (OHS) 122 system. The OHS system 122 is a higher speed, higher volume transport system to move production material between (interbay) production bays X 102, Y 104 and Z 106. The OHS system 122 supplements the movement of material by the OHT system 120. The typical OHS system 122 is constructed as either a rail or other conveyor system located above the manufacturing tools 108-112, work areas and the OHT system 120. The rails of a typical OHS system are usually positioned at a different height (usually higher) than the rail section of a typical OHT system. The OHS system 122 also utilizes platforms or vehicles to move the pods or cassettes of production material on predetermined routes or tracks. The combined usage and routings of both OHT 120 and OHS 122 rail sections effectively facilitate production material movement throughout the entire IC manufacturing facility.

FIG. 2 illustrates a plan view of a typical IC manufacturing facility with the OHT and OHS material transport systems as described by FIG. 1. The manufacturing facility 200 comprises of many production bays 202 with multiple production tools 204 located within each bay. An OHT rail section 206 provides transport access to each production bay 202 with transport routes/rails located within the production bays 202, between the bay stockers 208 as well as along the main corridor 210 of the manufacturing facility 200. The layout of the OHT rail section 206 establishes routes throughout the entire facility 200, connecting intrabay and interbay areas.

An OHS rail section 212 is also shown in FIG. 2. The OHS rail section 212 is located in the main corridor 210 of the manufacturing facility 200 and serves only as an interbay transport, connecting only to the bay stockers 208 of all production bays 202. The transport area serviced by the OHS rail section 212 is a subset of the area serviced by the OHT rail section 206.

The integration of the OHT and OHS rail sections requires factory automation controls to effectively coordinate and schedule the activities of the two separate material transport systems throughout the entire facility. Coordination is required to utilize the advantage of interfacing a high speed, short route OHS transport system with the primary all-duty, all-purpose, long route OHT transport system. The automation control software for the two systems must also be sufficiently robust to prevent or minimize material movement/transfer conflicts and system deadlocks.

Factory construction and layout planning must conform to the non-matching ceiling height requirements of both the OHT and OHS transport systems. Particularly, construction for and expansions to an OHS transport system may be costly if ceiling height is insufficient. IC manufacturing facilities are constructed as clean room environments. Construction costs for clean rooms are proportional to the clean room volume constructed. The higher ceiling height requirement for OHS systems adds extra construction cost premiums for the clean room space, attributed only to the OHS system. In addition, the operational costs related to maintaining the clean environment of the extra volume are also higher.

What is needed is a well-integrated material transport system that does not require the high cost requirements of mismatched ceilings heights in the manufacturing facility. An efficiently integrated dual rail section that services both the interbay OHS and the intrabay OHT systems maintains the benefits of utilizing high-speed transports with moderate speed transport systems. Improved transfer methods between such dual rail sections may further improve the transfer volume and transfer times of the production material.

### SUMMARY

An integrated material transport system in an integrated circuit manufacturing factory is disclosed. The system comprises a first material transport subsystem traveling at a first height, and a second material transport subsystem traveling at a second height. There is at least one shared material transfer port to be used by both the first and second transport subsystems. Further, there is an integrated rail subsystem servicing both the first and second material transport subsystems for exchanging predetermined materials through the shared material transfer port with a predetermined material stocker under a ceiling with a uniform height.

These and other aspects and advantages will become apparent from the following detailed description, taken in conjunction with the accompanying drawings, illustrating by way of example the principles of the disclosure.

### BRIEF DESCRIPTION OF THE DRAWINGS

FIG. 1 is a block diagram to illustrate the integration of material transport systems within a typical IC manufacturing facility.

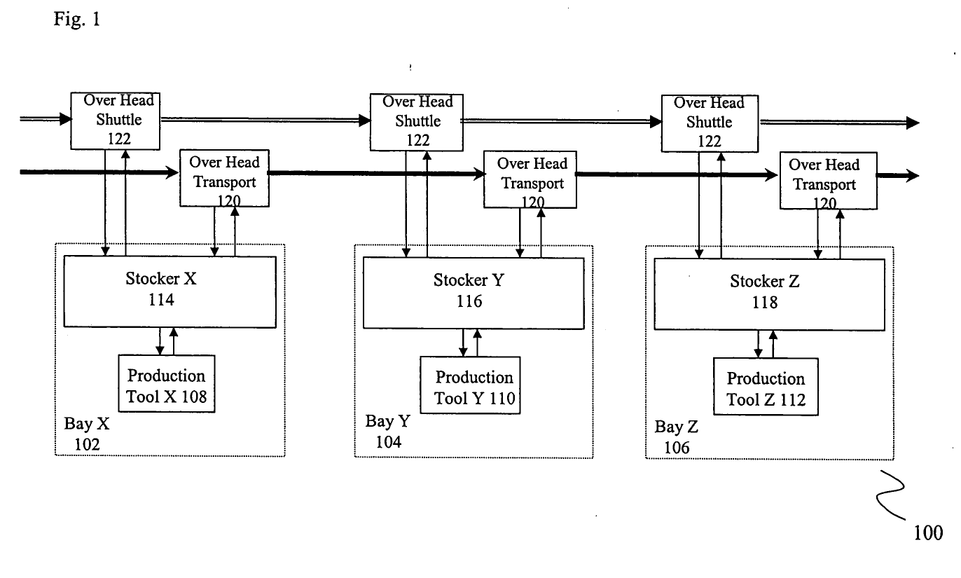

FIG. 2 is a plan view of a typical IC manufacturing facility illustrating the layouts of the material transport systems, rails, production bays, material stockers and production tools.

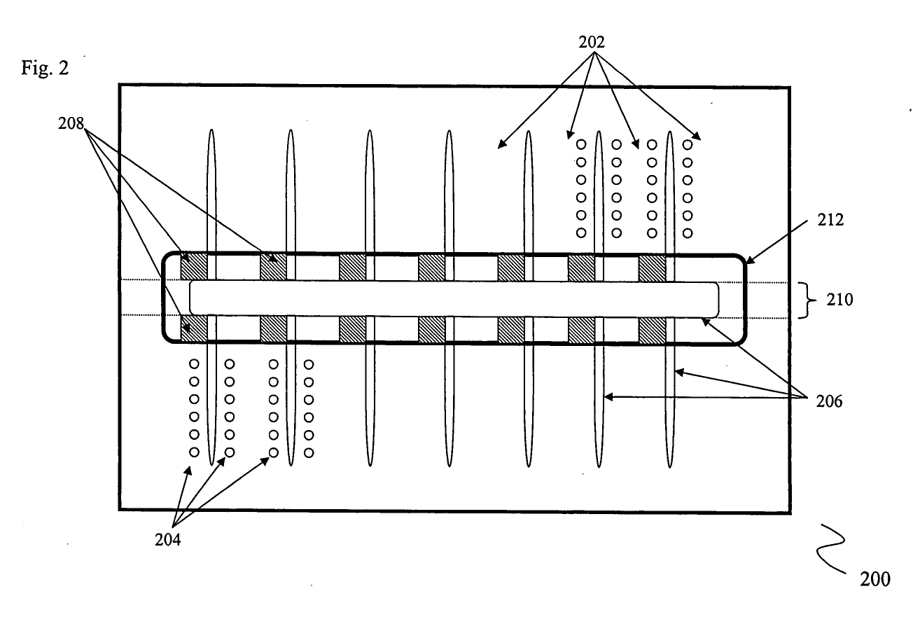

FIG. 3 is a cross-sectional view of a typical IC manufacturing facility illustrating the positions of the material transport systems, rails, production bays, and material stockers.

FIG. 4 is a cross-sectional view of an IC manufacturing facility illustrating the positions of the material transport systems, rails, production bays, and material stockers according to the methods of the present disclosure.

### DESCRIPTION

The present disclosure describes a method for integrating a low cost, dual rail/conveyor material transport system within an IC manufacturing facility. The integration methodology of the disclosure also improves material volume handling capability as well as improvement for material transfer rates at the material input and output transfer ports.

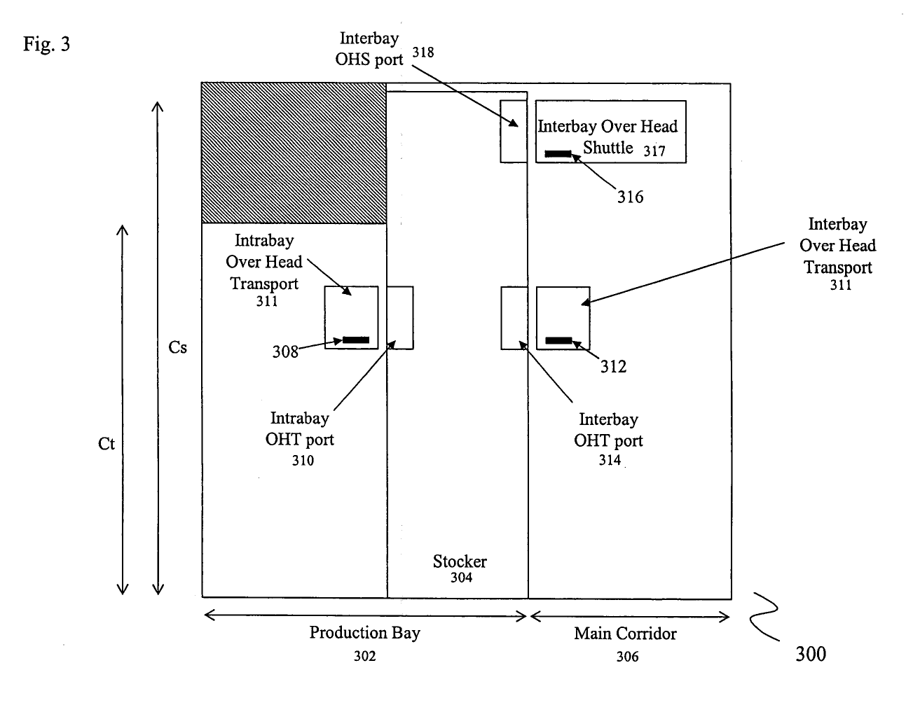

FIG. 3 illustrates a cross-sectional view of a typical IC manufacturing facility with an integrated material transport system 300. This view of the manufacturing facility shows a production bay 302, its assigned material stocker 304 and the main corridor 306, located just outside of the production bay 302. An intrabay rail section 308 of a first material transport subsystem such as an over head transport (OHT) system 311 is shown located inside the production bay 302 with an intrabay OHT transfer port 310 used for the transfer of material between the material stocker 304 and the OHT 311. This intrabay rail section 308 of the OHT system 311 provides transport service inside (intrabay) the production bay 302. As shown, another interbay OHT rail section 312 and an interbay OHT material stocker transfer port 314 are located at the main corridor 306 side of the material stocker 304. This interbay rail section 312 of the OHT system 311 provides transport service between (interbay) the stockers 304 of the production bays 302. The ceiling height, Ct, of the production bay 302 is typically 3 to 5 meters, sufficient to accommodate both the hardware and rail requirements of the OHT system and the unobstructed work space clearance for production work.

A rail section 316 of another material transport subsystem such as an over head shuttle (OHS) system 317 is also shown in FIG. 3. The interbay OHS transport rail section 316 is located outside of the production bay 302 in the manufacturing facilities' main corridor 306. The associated interbay OHS material transfer port 318 is located at the main corridor 306 side of the material stocker 304. The interbay OHS system 317 and its associated interbay transfer port 318 are located at a height, Cs, that is sufficiently higher than that of the interbay OHT system 311 and production bay 302 ceiling height Ct. The interbay OHS system 317 requires a higher ceiling height Cs sufficient to accommodate the working hardware and rail of the system and the working hardware of the OHT system 311 located below it. The ceiling height as illustrated on FIG. 3 as Cs, of a typical OHS system 317, is usually 4 to 7 meters. Typical manufacturing facilities maintain the lower ceiling height Ct within the production bays 302 and the required higher ceiling height Cs in the fabrication areas encompassing the interbay OHS system 317.

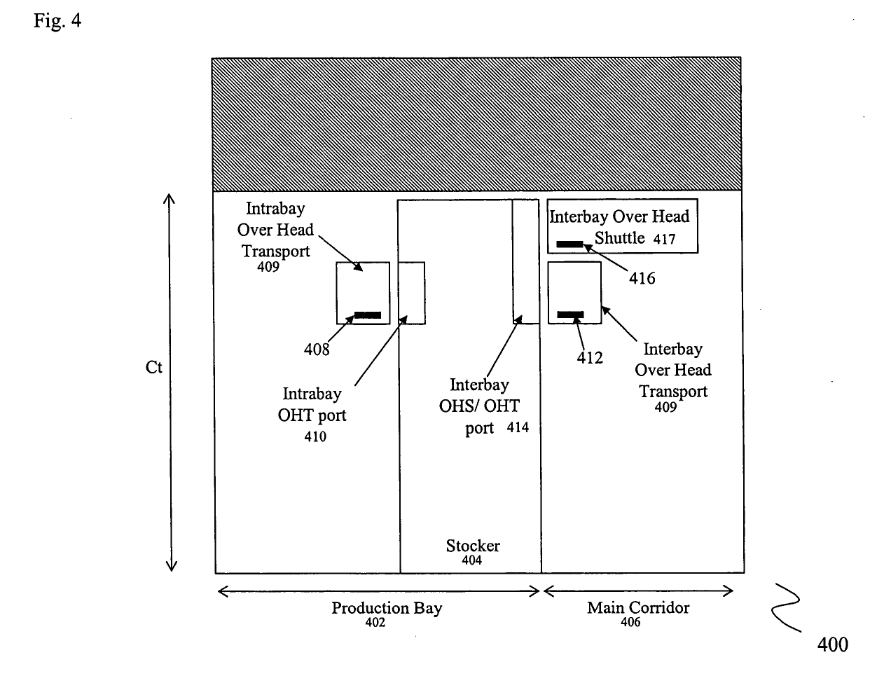

Referring now to FIG. 4, there is shown a sectional side view of an IC manufacturing facility in accordance to the methods of the present disclosure. This view of the manufacturing facility shows a production bay 402, its assigned material stocker 404 and the main corridor 406 located just outside of the production bay 402. An intrabay rail section 408 of the OHT system 409 is shown located inside the production bay 402 with an intrabay OHT transfer port 410 used for the transfer of material between the material stocker 404 and OHT system 409. The intrabay rail section 408 of the OHT system provides transport service inside (intrabay) the production bay 402. The above-described components of the production facility are the same as that of the typical production facility as illustrated by FIG. 3. The ceiling height Ct of the production bay 402 may be the same height as or of minimal difference from the height as described in FIG. 3.

Shown in FIG. 4, another OHT interbay rail section 412 and an interbay material stocker transfer port 414 are located at the main corridor 406 side of the material stocker 404. This interbay rail section 412 of the OHT system 409 provides transport service between (interbay) the stockers 404 of the production bays 402. Comparing to the system in FIG. 3, the interbay material transfer port 414 located on the main corridor 406 side of the production bay 402, is expanded and larger than the typical interbay material transfer port 314 described in FIG. 3. This larger, expanded interbay port 414 serves as the material transfer port between the rail section of the OHT 412 and another rail section 416 for the OHS system 417 and the material stockers 404 of the present disclosure.

FIG. 4 shows an interbay rail section 416 of the OHS transport system 417 located outside of the production bay 402, in the manufacturing facilities' main corridor 406. The associated, shared interbay material transfer port 414 is shown located at the main corridor 406 side of the material stocker 404. As previously stated, the interbay material transfer port 414 serves as the shared material transfer port for both rails of the OHT 409 and OHS 417 transport systems, for interface with the material stockers 404.

The shared interbay material transfer port 414 allows for the hardware of the OHS transport rail 416 to be located at a lower height than that as described for FIG. 3. For this example of the present disclosure, the ceiling height of the facility encompassing the OHS system 417 is at the same height as that of the production bay 402, shown in FIG. 4 as height Ct. The cross-sectional view shows the ceiling height of the entire manufacturing facility to be uniform at one height Ct, contrasted to the offset ceiling heights Ct and Cs illustrated in FIG. 3. for a typical manufacturing facility. It is noticed that although the rail sections are shown to be separate, they are integrated together to be controlled coherently. For example, they can be controlled through a single control module top make sure that there is no conflicts in the use of the rail anytime during the operation. As an alternative, the upper rail section 416 can be controlled by one control module, and the lower rail section 408/412 can be controlled by another control module, with both controller being further integrated together. In this sense, the rail including the upper and lower rail sections can be viewed as an integrated rail subsystem.

The uniform ceiling height made available in this improved design can be accomplished by having a well-integrated dual rail design that accommodates both the interbay OHS and intrabay OHT material transport systems. The use of a single, shared port for material transfers in and out of the material stockers allows for the placement of the two rail sections closely together. With an expanded material transfer port opening that now extends up to the ceiling height of the production bay, the higher OHS transport system may be lowered to fit within this ceiling height.

The uniform, lower ceiling height reduces the entire volume of the manufacturing facility, thus providing lower costs for clean room construction and maintenance. The use of the integrated transport, integrated dual rail/conveyor systems maintain the benefits of combining high speed, short route material transport with moderate speed, long route transport systems. The shared transfer ports between the OHT and OHS systems allow for more seamless integration of the factory automation controls for the coordination and scheduling of material movement on the dual transports. Seamless integration will lessen the probability for system conflicts and deadlocks as well as providing more efficient algorithms for controlling material movement.

The shared transfer ports and lowered ceiling heights also provide improvements for material transfer rates. The distance material travels between the material stockers and transfer ports are shorter. Improved transfer rates and material movement efficiencies will improve overall capabilities of the transport systems for handling additional material volume.

The above disclosure provides an example for implementing features of the invention. Specific examples of components and processes are described to help clarify the invention. These are, of course, merely examples and are not intended to limit the invention from that described in the claims.

While the invention has been particularly shown and described with reference to the preferred embodiment thereof, it will be understood by those skilled in the art that various changes in form and detail may be made therein without departing from the spirit and scope of the invention, as set forth in the following claims.

1. An integrated material transport system for an integrated circuit manufacturing factory, the system comprising:
a first material transport subsystem traveling at a first height;
a second material transport subsystem traveling at a second height; and
at least one shared material transfer port to be used by both the first and second transport subsystems,
wherein both the first and second material transport subsystems serviced by an integrated rail subsystem for exchanging predetermined materials through the shared material transfer port with a predetermined material stocker under a ceiling with a uniform height.

2. The system according to claim 1 wherein the first material transport subsystem is an intrabay material transport subsystem for providing material transfer within a production bay or between the production bay and the predetermined material stocker.

3. The system according to claim 2 wherein the predetermined material stocker is located between the production bay and a main corridor.

4. The system according to claims 1 wherein the second material transport subsystem is an interbay material transport subsystem for providing material transfer between the predetermined material stocker and at least one other material stocker.

5. The system according to claim 1 wherein the second material transport subsystem is located outside of a production bay and within a main corridor.

6. The system according to claim 1 wherein the material transfer port has an elongated opening for accommodating both the first material transport subsystem and the second material transport subsystem.

7. The system according to claim 1 wherein the material transfer port is located on a main corridor side of the predetermined material stocker.

8. The system according to claim 1 wherein the ceiling height is approximately 3-5 meters.

9. The system according to claim 1 wherein the integrated rail subsystem has two rails at different heights for servicing the first and second material transport subsystems simultaneously.

10. An integrated material transport system for an integrated circuit manufacturing factory, the system comprising:
a first material transport subsystem having at least one over head transport module traveling at a first height for providing material transfer within a production bay or between the production bay and the predetermined material stocker;
a second material transport subsystem having at least one over head shuttle traveling at a second height for providing material transfer between the predetermined material stocker and at least one other material stocker;
at least one shared material transfer port to be used by both the first and second transport subsystems; and
an integrated rail subsystem servicing both the first and second material transport subsystems at the first and second heights for exchanging predetermined materials through the shared material transfer port with a predetermined material stocker so that the factory does not need different portions of its ceiling having different heights to accommodate the first and second material transport subsystems.

11. The system according to claim 10 wherein the material transfer port has an elongated opening for accommodating both the over head shuttle and the over head transport.

12. The system according to claim 10 wherein the material transfer port is located on a main corridor side of the predetermined material stocker.

13. The system according to claim 10 wherein the factory has a ceiling height of approximately 3-5 meters.

14. The system according to claim 10 wherein the integrated rail subsystem has two rails at different heights for servicing the first and second material transport subsystems simultaneously.

15. A method for integrating intrabay and interbay material transport systems in an integrated circuit manufacturing factory, the method comprising:
providing a first material transport system;
providing a second material transport system; and
providing at least one shared material transfer port for both the first and second transport systems,
wherein an integrated rail section services both the first and second material transport systems for exchanging predetermined materials through the shared material transfer port with a predetermined material stocker under a ceiling with a uniform height.

16. The method according to claim 15 wherein the first material transport system is an intrabay material transport system for providing material transfer within a production bay or between the production bay and the predetermined material stocker.

17. The method according to claim 16 wherein the predetermined material stocker is located between the production bay and a main corridor.

18. The method according to claims 15 wherein the second material transport system is an interbay material transport system for providing material transfer between the predetermined material stocker and at least one other material stocker.

19. The method according to claim 15 wherein the second material transport system is located outside of a production bay and within a main corridor.

20. The method according to claim 15 wherein the material transfer port has a size sufficient to accommodate both the first material transport system and the second material transport system.

21. The method according to claim 15 wherein the material transfer port is located on a main corridor side of the predetermined material stocker.

22. The method according to claim 15 wherein the uniform ceiling height is approximately 3-5 meters.

23. The method according to claim 15 wherein the integrated rail section has two rail subsystems at different heights for servicing the first and second material transport systems simultaneously.
